(19) United States
(12) Patent Application Publication
(10) Pub. No.: US 2019/0197908 A1
(43) Pub. Date: Jun. 27, 2019

(54) METHODS AND SYSTEMS FOR IMPROVING THE PRECISION OF AUTONOMOUS LANDINGS BY DRONE AIRCRAFT ON LANDING TARGETS

(71) Applicants: Reese A. Mozer, Medford, MA (US); Eitan Babcock, Medford, MA (US); Zach Harvey, Medford, MA (US)

(72) Inventors: Reese A. Mozer, Medford, MA (US); Eitan Babcock, Medford, MA (US); Zach Harvey, Medford, MA (US)

(21) Appl. No.: 16/102,196

(22) Filed: Aug. 13, 2018

Related U.S. Application Data
(60) Provisional application No. 62/545,203, filed on Aug. 14, 2017.

(51) Int. Cl. G08G 5/02; G08G 5/00; G05D 1/06; B64C 39/02

(52) U.S. Cl. CPC G08G 5/025; G08G 5/0047; B64C 2201/127; B64C 39/024; B64C 2201/141; G05D 1/0676

(57) ABSTRACT

Methods and system are disclosed for guiding an autonomous drone aircraft during descent to a landing target. The method features the steps of: (a) acquiring an image using a camera on the drone aircraft of an active fiducial system at the landing target; (b) verifying the active fiducial system in the image by comparing the image to a stored model or representation of the active fiducial system; (c) determining a relative position and/or orientation of the drone aircraft to the landing target using data from the image; (d) using the relative position and/or orientation determined in step (c) to guide the drone aircraft toward the landing target; and (e) repeating steps (a) through (d) a plurality of times.

### CROSS REFERENCE TO RELATED APPLICATION

This application claims priority from U.S. Provisional Patent Application No. 62/545,203 filed on Aug. 14, 2017 entitled METHODS AND SYSTEMS FOR IMPROVING THE PRECISION OF AUTONOMOUS LANDINGS BY DRONE AIRCRAFT ON LANDING TARGETS, which is hereby incorporated by reference.

### BACKGROUND

The present application relates generally to autonomous drone aircraft and, more particularly, to methods and systems for precisely landing such aircraft on landing targets using active fiducial markers.

VTOL (vertical take-off and land) aircraft, such as multirotor copters (e.g., quadcopters) and similar aircraft, can be configured as autonomous drones that include software enabling the drone to perform one or more functions on its own (e.g., flying a particular route, taking off, and landing). These systems can be configured to land on a particular landing target, such as a docking station, base station, hanger, runway, or the like. Landing targets can be stationary or moving. They can be used, e.g., to charge, transfer data, swap components, and/or house the aircraft. These systems can employ GPS navigational mechanisms, vision sensors, inertial measurement sensors, distance sensors, or the like.

However, traditional combinations of software and sensors, such as GPS, inherently include positional errors. As shown in FIG. 1, such errors can lead to misalignment of the drone 100 relative to a landing target 104 during landing. Such misalignment can prevent the drone from making a physical or electromagnetic connection with the landing target 104, thereby preventing data transfer, object retrieval (e.g., for package delivery), safe enclosure of system, and/or charging of the drone's battery without manual intervention.

### BRIEF SUMMARY OF THE DISCLOSURE

In accordance with one or more embodiments, a computer-implemented method is disclosed of guiding an autonomous drone aircraft during descent to a landing target. The method features the steps of: (a) acquiring an image using a camera on the drone aircraft of an active fiducial system at the landing target; (b) verifying the active fiducial system in the image by comparing the image to a stored model or representation of the active fiducial system; (c) determining a relative position and/or orientation of the drone aircraft to the landing target using data from the image; (d) using the relative position and/or orientation determined in step (c) to guide the drone aircraft toward the landing target; and (e) repeating steps (a) through (d) a plurality of times.

In accordance with one or more further embodiments, a system is disclosed comprising an active fiducial system at a landing target and an autonomous drone aircraft capable of landing at the landing target. The autonomous drone aircraft includes a camera for acquiring an image of the active fiducial system. The autonomous drone aircraft also includes a control system configured to: (a) verify the active fiducial system in the image by comparing the image to a stored model or representation of the active fiducial system; (b) determine a relative position and/or orientation of the drone aircraft to the landing target using data from the image; (c) use the relative position and/or orientation determined in (c) to guide the drone aircraft toward the landing target; and (e) repeat (a) through (d) a plurality of times for successive images acquired by the camera.

### BRIEF DESCRIPTION OF THE DRAWINGS

FIG. 1 is a simplified diagram illustrating misalignment of a drone aircraft to a docking station.

FIG. 2 is a simplified block diagram illustrating a representative autonomous drone aircraft in accordance with one or more embodiments.

FIG. 3 is a simplified diagram illustrating drone offset along the z-axis relative to a docking station.

FIG. 4 is a simplified diagram showing a landing target outside of the drone camera field of view (FOV) when the drone is at a low altitude.

FIG. 5 illustrates a representative square-shaped fiducial marker constellation pattern in accordance with one or more embodiments.

FIG. 6 illustrates a representative circular-shaped fiducial marker constellation pattern in accordance with one or more embodiments.

FIG. 7 illustrates a representative line-shaped fiducial marker constellation pattern in accordance with one or more embodiments.

FIG. 8 illustrates a representative fiducial marker constellation pattern with a center fiducial in accordance with one or more embodiments.

FIG. 9 shows a flow chart illustrating an exemplary process for utilizing a set of active fiducial markers to precisely land a drone aircraft in accordance with one or more embodiments.

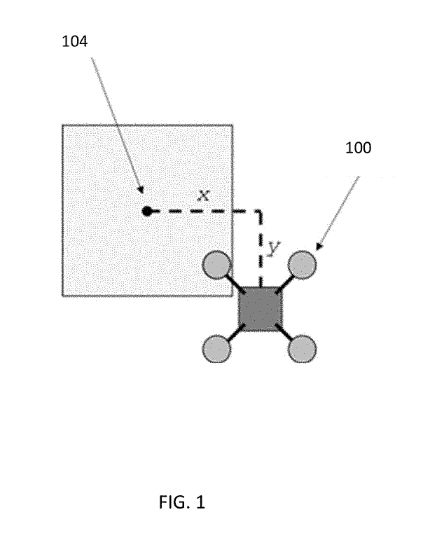

Like or identical reference numbers are used to identify common or similar elements in the drawings.

### DETAILED DESCRIPTION

Various embodiments disclosed herein relate to methods and systems for improving the precision of autonomous landings by drone aircraft using active fiducial markers at landing targets.

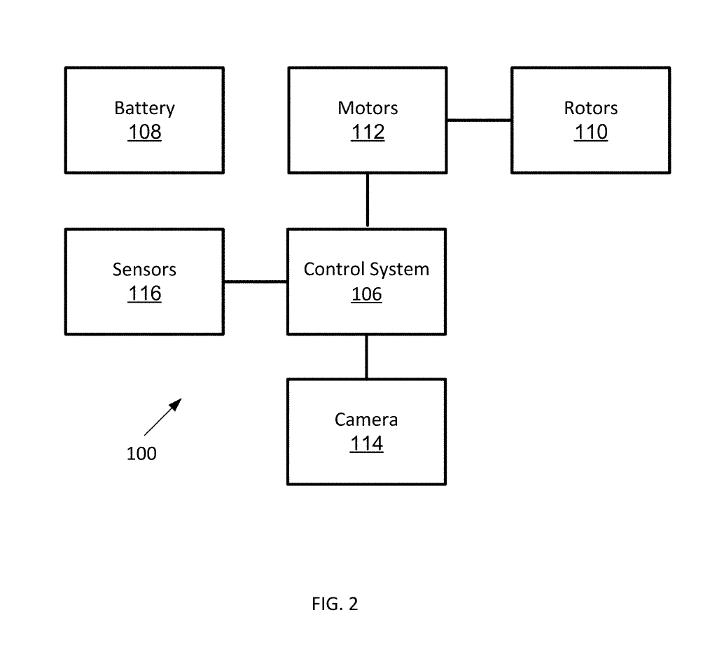

FIG. 2 is a simplified block diagram of select components of a representative drone aircraft 100 in accordance with one or more embodiments. The drone aircraft 100 includes a control system 106 for controlling operation of the aircraft, a battery 108 for powering the aircraft, a set of rotors 110 driven by motors 112, a camera 114, and sensors 116. The sensors 116 can include, e.g., a GPS device, an inertial measurement sensor, a distance sensor, and a barometer.

The control system includes a flight controller system for maneuvering the drone by controlling operation of the rotors 110. The control system also includes a vision system that uses computer vision techniques for detecting a set of active fiducial markers at a landing target for improving the precision of landings as will be discussed in further detail below.

The control system can include one or more microcontrollers, microprocessors, digital signal processors, application-specific integrated circuits (ASIC), field programmable gate arrays (FPGA), or any general-purpose or special-purpose circuitry that can be programmed or configured to perform the various functions described herein.

Computer vision techniques are used in accordance with one or more embodiments to improve the precision of the autonomous drone landing, and thus the reliability of a successful docking event with a docking station. In accordance with one or more embodiments, one or more fiducial markers, such as light-emitting beacons, of known position and arrangement are configured at the landing target. The fiducials along with the camera 114 mounted on the drone aircraft in a known position and orientation, enable high-speed state estimation of the aircraft relative to the landing target. This state estimate, i.e., relative position and/or orientation, is used to control the aircraft precisely during the descent until successful landing has been achieved.

Using light-emitting fiducials are beacons has several benefits. One significant benefit is the ability to match the wavelength of the light emitted by the beacon with a band-pass filter on the camera that only allows that wavelength of light to be imaged. By choosing these values, it allows an image analysis algorithm used in the vision system to extract the fiducial features much more easily than standard computer vision techniques.

Such fiducials improve multiple things: the likelihood of detecting and segmenting an information-producing feature from the unrelated background features, the computational speed at which this detection can happen, and the accuracy and precision of the position and/or orientation measurements that can be derived. Each improvement increases the likelihood of precise control during landing.

In one or more embodiments, the fiducial-camera system can be optimized to further block-out unwanted background noise by tuning the camera to a narrow band of light known to be emitted by the fiducial. In addition to visible spectrum light, such light can be infrared or other non-visible spectra.

Important to a smooth, reliable, and precise autonomous landing are accurate, high-speed estimates of relative (i.e., above target level) position (i.e., x, y, and z), and relative orientation (i.e., roll, pitch, and yaw). These are the six degrees of freedom of a rigid body in three-dimensional space. A single fiducial point, however, will only generate information in two of these degrees of freedom, e.g., x and y. Though useful, it is often insufficient to only rely on these two dimensions for precise, reliable control.

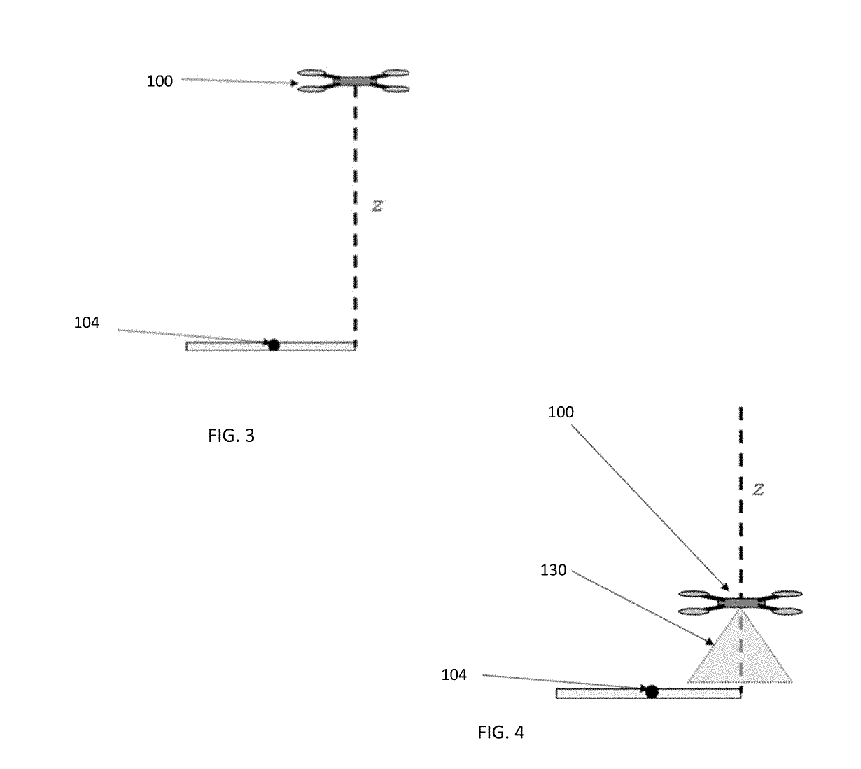

For example, as illustrated in FIG. 3, current altitude sensors, or sensors that measure an aircraft's relative position along the z-axis, are often not sufficient to guarantee a reliable and accurate precision landing. For example, current GPS units and barometers often provide measurements with errors on the order of multiple meters. In addition, sonar and laser range finders can be unreliable over terrain with varying heights, such as the difference between the top surface of a docking station and the ground.

To overcome this, multiple fiducial markers of known positions, e.g., in a fiducial constellation, can be used to extract relative pose in multiple degrees of freedom. For example, a fiducial constellation consisting of two points with known spacing can be used to extract distance information. The number of pixels between the points in the image, combined with the known spacing in the real world, allows the distance between the camera and the fiducial to be calculated. In the case where the camera is pointed down, this distance is equivalent to the altitude.

The landing procedure for an aircraft in this scenario naturally involves starting at farther distances and approaching towards the target until the aircraft has landed. To properly utilize a fiducial constellation system such as the one described above, limitations of camera resolution and camera FOV at these various distances should be addressed.

At higher altitudes, the restrictions on pixel resolution may cause the camera to be unable to distinguish smaller-dimensioned fiducial arrangements from each other and from the background. For example, if one used a constellation of four light-emitting beacons arranged in a square pattern to extract relative x, y, and z position, at higher altitudes these points may appear too close together or too dim to extract any useful information. At these higher altitudes, the fiducial constellation is small in the camera image. In this case, a single pixel of error is a larger percentage of the overall constellation size in the image as compared to lower altitudes where the constellation is larger in the image.

At lower altitudes, the restrictions of a static FOV will cause the camera to view smaller and smaller physical areas. As shown in FIG. 4, as the aircraft approaches the landing target 104, a constellation that had appropriate dimensions for a higher altitude (i.e., spaced far apart) may exist outside the FOV 130 of the camera at this lower altitude with its previous offset along the x and y axes, rendering it unusable.

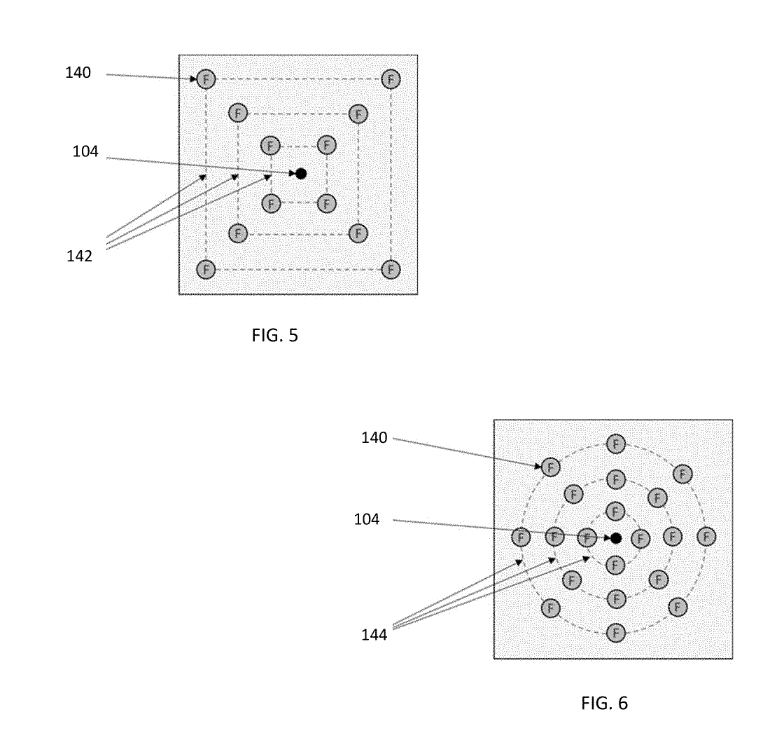

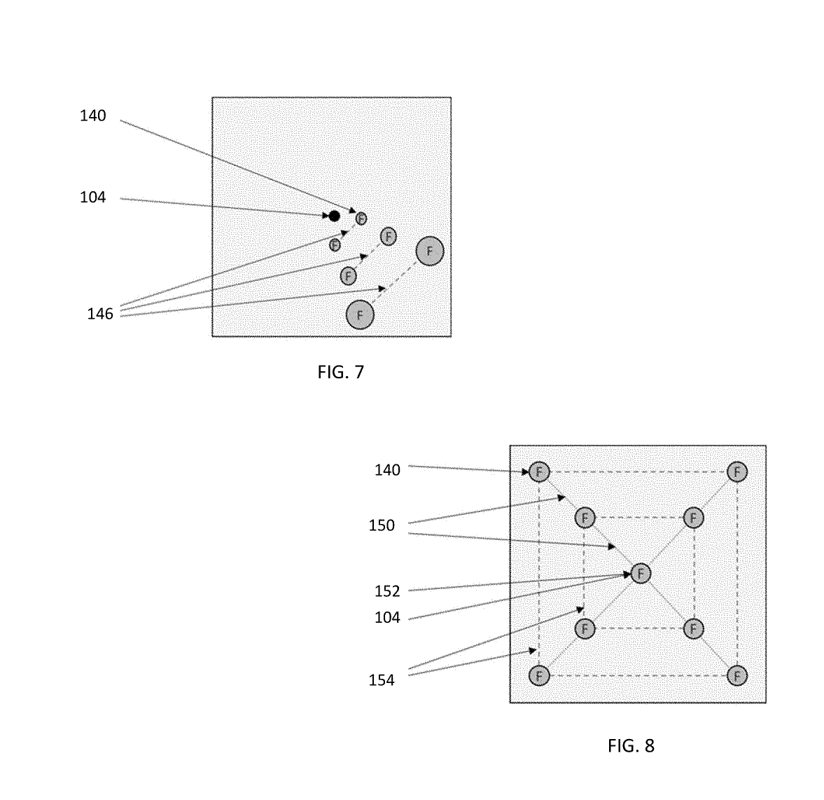

In accordance with one or more embodiments, to overcome this technical hurdle, a set of progressively smaller constellations are used that are appropriate for each stage of the descent, guiding the aircraft into its final, precise location. By way of example, as shown in FIG. 6, such constellations can comprise a series of nested circles 144 (each circle comprising multiple fiducials 140 arranged in a circular pattern) with decreasing diameters. FIG. 5 shows constellations comprising a series of squares 142 (each square comprising multiple fiducials 140 arranged in a square pattern) with decreasing dimensions. FIG. 7 shows a series of lines 146 (each line comprising multiple fiducials 140 arranged in a line). Suitable fiducials systems could include any combination or permutation of fiducial constellations that get progressively smaller (i.e. closer to the center point of the camera FOV) as the aircraft approaches the landing target.

Alternatively, instead of using multiple beacons, a “single” fiducial having a two-dimensional form (such as a solid square or circle) may be used to elicit the same information. In other embodiments, multiple beacons can be arranged, e.g., next to one another (e.g., in an LED strip) to form such a continuous shape.

Alternatively, the camera may have an adjustable field of view (FOV) that allows the camera to gradually widen the field of view and zoom out as the vehicle approaches the landing target. This would produce a similar effect.

In one or more optional exemplary embodiments, to utilize such a constellation of beacons for precision landing, the constellation must appear within the FOV of the drone-mounted camera. To improve this likelihood of this scenario, the constellation is preferably constructed in a pattern equidistant from the center point of the landing target, or symmetrical about the x and y axes, so that position errors do not produce a biased negative effect in any particular direction. Possible exemplary embodiments of this are a set of multiple beacons arranged in a square pattern, a set of multiple beacons arranged in a circular pattern, or the like. Also, instead of multiple beacons, a “single” fiducial having a two-dimensional form (such as a solid square or circle) may be used to elicit the same information. Multiple beacons can be arranged next to one another (e.g., in an LED strip) to form a continuous shape.

In an alternate embodiment, one or more of the series of constellations may be offset by known distances from the center point of the landing target.

However, perfect radial symmetry is not preferred because it introduces ambiguity in the orientation of the constellation. For example, a perfect square constellation looks identical when viewed from any of four directions (rotated by 90 degrees). This type of constellation would require additional information to resolve the ambiguous solutions to the correct orientation. One solution to this is to use the other sensors, e.g. magnetometer, to resolve the ambiguity. Another solution is to add one or several asymmetrically located beacons in the constellation. For example, add a fifth beacon to the square constellation that is not symmetric. This allows the algorithm to independently eliminate ambiguity in a self-contained manner, without additional sensors.

In one or more exemplary embodiments, a center fiducial is provided. The center fiducial is aligned with the drone-mounted camera to maximize the locations from which the fiducial will be within the FOV of the camera. The center fiducial will be lined up with the center of the image during an ideal descent, and can be viewed the entire landing process until the drone is on the landing target.

This allows the vision estimate to guide the control for the entire landing procedure, if at the very least with a single fiducial. If this is not done, the last portion of the descent may not have information from the camera system, and will therefore be relying solely on the imprecise sensors mentioned previously (e.g., GPS) and could drift away from the landing target in the final moments.

As shown in FIG. 8, the presence of a center fiducial 152 also increases the number of fiducials for each and every constellation 154 by one (i.e. a 5-point star vs. a 4-point square), with the position of this center fiducial increasing the likelihood that at least two points will be viewed at all times for each constellation, thus increasing the robustness of the estimate. Center fiducial constellation connectors are indicated at 150.

The center fiducial 152 can also be used with fiducials having a two-dimensional form such as the solid square or circle discussed above.

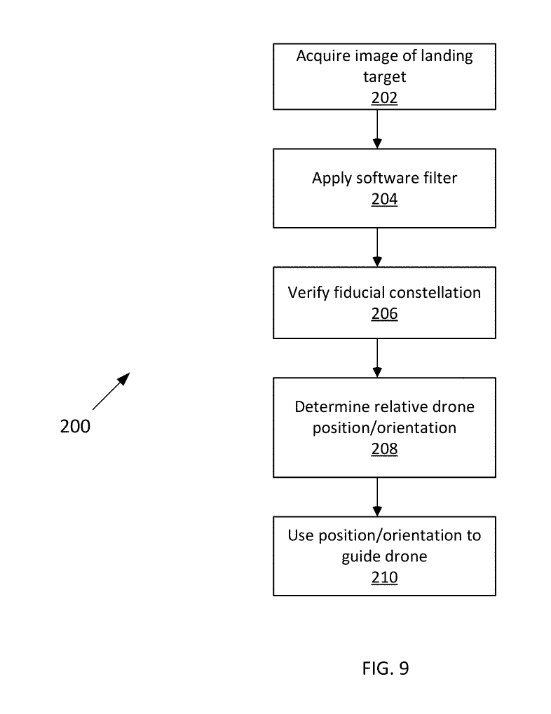

FIG. 9 shows a flow chart 200 illustrating an exemplary process for utilizing a set of active fiducial markers at the landing site to precisely land a drone in accordance with one or more embodiments.

At step 202, an image of the landing site with the active fiducial markers is acquired by the camera 114 on the drone. In accordance with one or more embodiments, the camera is equipped with a band pass filter matching the frequency of light known to be emitted by the fiducial markers. The camera thus captures a darkened image with substantially only white features representing the fiducial markers.

At step 204, the vision system processes the acquired image by applying a software filter to the image to filter out unrelated background features like reflections from the sun and other objects.

At step 206, the vision system verifies the presence of the fiducial markers in the image. The vision system knows the general estimated position/orientation of the drone relative landing target based on location information received from sensors on the drone (e.g., a GPS device and barometer) or from a previous position/orientation estimate from the vision system if available. The vision system also stores in memory a representation or model of the fiducial marker system in memory. The representation or model defines the arrangement of fiducial markers in the fiducial system. The representation or model can be, e.g., an image of the fiducial marker system or data specifying the (x, y, z) coordinates of the fiducial markers.. The vision system compares the captured image to the stored representation or model, accounting for distortions in the captured image based on the relative position/orientation of the drone to the landing site. The vision system thereby verifies the fiducial constellation in the image and also uniquely identifies each of the fiducial markers in the constellation.

At step 208, the vision system uses the captured image to determine its relative position/orientation to the landing site.

At step 210, the vision system provides the position/orientation information to the flight controller, which guides the drone to the landing site.

These steps are continuously repeated until the drone has successfully landed at the landing site. The camera 114 continuously captures images, e.g., at 50 frames per second. The image analysis described above is repeated for each frame.

The processes of the control system described above may be implemented in software, hardware, firmware, or any combination thereof. The processes are preferably implemented in one or more computer programs executing on one or more processors in the control system. Each computer program can be a set of instructions (program code) in a code module resident in a random access memory of the control system. Until required by the controller, the set of instructions may be stored in another computer memory.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments.

Additionally, elements and components described herein may be further divided into additional components or joined together to form fewer components for performing the same functions.

Accordingly, the foregoing description and attached drawings are by way of example only, and are not intended to be limiting.

1. A computer-implemented method of guiding an autonomous drone aircraft during descent to a landing target, comprising the steps of:
(a) acquiring an image using a camera on the drone aircraft of an active fiducial system at the landing target;
(b) verifying the active fiducial system in the image by comparing the image to a stored model or representation of the active fiducial system;
(c) determining a relative position and/or orientation of the drone aircraft to the landing target using data from the image;
(d) using the relative position and/or orientation determined in step (c) to guide the drone aircraft toward the landing target; and
(e) repeating steps (a) through (d) a plurality of times.

2. The method of claim 1, wherein step (a) further comprises filtering the image using a band pass filter passing only light having light frequency known to be emitted by the active fiducial system.

3. The method of claim 1, further comprising using a software filter on the image acquired in step (a) to filter out background features.

4. The method of claim 1, wherein step (b) utilizes position and/or orientation information of the drone aircraft relative to the landing target acquired from sensors on the drone aircraft.

5. The method of claim 4, wherein the sensors comprise a GPS device and a barometer.

6. The method of claim 1, wherein step (b) utilizes position and/or orientation information obtained in step (c) for a previously acquired image of the active fiducial system.

7. The method of claim 1, wherein the camera has a fixed field of view, and wherein the active fiducial system comprises fiducial constellations are progressively smaller as they approach the landing target.

8. The method of claim 7, wherein the fiducial constellations comprise a series of lines or nested shapes.

9. The method of claim 1, the active fiducial system comprises a single fiducial marker having a two-dimensional form.

10. The method of claim 1, wherein the camera has an adjustable field of view configured to widen the field of view as the aircraft approaches the landing target.

11. The method of claim 1, wherein the fiducial system comprises fiducial constellations arranged in a pattern equidistant from a center point of the landing target.

12. The method of claim 11, wherein the fiducial system further comprises a center fiducial marker located at the center point of the landing target.

13. The method of claim 1, wherein the fiducial system comprises fiducial constellations offset by known distances from a center point of the landing target.

14. The method of claim 1, wherein the fiducial system comprises fiducial constellations containing fiducial markers that are asymmetrically arranged relative to a center point of the landing target.

15. A system, comprising:
an active fiducial system at a landing target; and
an autonomous drone aircraft capable of landing at the landing target, said autonomous drone aircraft including a camera for acquiring an image of the active fiducial system, said autonomous drone aircraft also including a control system configured to:
(a) verify the active fiducial system in the image by comparing the image to a stored model or representation of the active fiducial system;
(b) determine a relative position and/or orientation of the drone aircraft to the landing target using data from the image;
(c) use the relative position and/or orientation determined in (c) to guide the drone aircraft toward the landing target; and
(d) repeat (a) through (c) a plurality of times for successive images acquired by the camera.

16. The system of claim 15, wherein the camera includes a band pass filter passing only light having light frequency known to be emitted by the active fiducial system.

17. The system of claim 15, wherein the drone aircraft further comprises sensors for determining the position and/or orientation information of the drone aircraft relative to the landing target.

18. The system of claim 17, wherein the sensors comprise a GPS device and a barometer.

19. The system of claim 15, wherein the camera has a fixed field of view, and wherein the active fiducial system comprises fiducial constellations are progressively smaller as they approach the landing target.

20. The system of claim 19, wherein the fiducial constellations comprise a series of lines or nested shapes.

21. The system of claim 15, wherein the active fiducial system comprises a single fiducial marker having a two-dimensional form.

22. The system of claim 15, wherein the camera has an adjustable field of view configured to widen the field of view as the aircraft approaches the landing target.

23. The system of claim 15, wherein the fiducial system comprises fiducial constellations arranged in a pattern equidistant from a center point of the landing target.

24. The system of claim 23, wherein the fiducial system further comprises a center fiducial marker located at the center point of the landing target.

25. The system of claim 15, wherein the fiducial system comprises fiducial constellations offset by known distances from a center point of the landing target.

26. The system of claim 15, wherein the fiducial system comprises fiducial constellations containing fiducial markers that are asymmetrically arranged relative to a center point of the landing target.
